(19) United States
(12) Patent Application Publication
(10) Pub. No.: US 2026/0285207 A1
(43) Pub. Date: Sep. 24, 2026

(54) CHILD SAFETY SEAT WITH REMOVABLE BOOSTER

(71) Applicant: JOURNEY INNOVATION, LLC, Mount Joy, PA (US)

(72) Inventor: Mitchell L. SHELLENBERGER, Mount Joy, PA (US)

(21) Appl. No.: 19/681,429

(22) Filed: May 19, 2026

Related U.S. Application Data
(63) Continuation-in-part of application No. 18/304,742, filed on Apr. 21, 2023, now abandoned.
(60) Provisional application No. 63/333,458, filed on Apr. 21, 2022.

(51) Int. Cl. B60N 2/28

(52) U.S. Cl. CPC B60N 2/2866

(57) ABSTRACT

A child safety seat comprises a shell having a connecting rod fixed across a receiving portion and a booster removably received in the receiving portion. The booster carries one or more rotary-ratchet clamp assemblies, each having a locking wheel defining a clamping notch, a pawl, and a biasing element. The wheel axis is generally parallel to the connecting rod. Seating the booster drives the connecting rod into the notch, rotating the wheel from an open position to a captive position in which the notch wraps a substantial portion of the rod. The pawl locks the wheel against reverse rotation. A caregiver-operated actuator, optionally coupled to the pawls by a Bowden cable, releases the pawls to permit removal of the booster.

### CROSS-REFERENCE TO RELATED APPLICATIONS

This application is a continuation-in-part of, and claims priority under 35 U.S.C. §120 to, U.S. Nonprovisional Patent Application No. 18/304,742, filed April 21, 2023, which claims priority to U.S. Provisional Patent Application No. 63/333,458, entitled " Child safety seat with removable booster" filed April 21, 2022, the disclosure of which is incorporated herein by reference in its entirety.

### FIELD OF THE INVENTION

The subject matter of this application pertains to child safety seats. More specifically, it pertains to child safety seats for use in vehicles. Even more particularly, the subject matter of this application pertains to child safety seats comprised of a removable booster seat and a shell assembly, and to securing mechanisms for reversibly coupling a booster seat to a paired shell assembly.

### BACKGROUND OF THE INVENTION

Since cars first became common, those traveling with small children have faced the problem of how to transport them safely. Early child car seats were intended primarily to elevate the child so they could enjoy the view. Modern child car seats are engineered to prevent injury in a collision rather than to provide a better view.

As a child outgrows a harnessed child car seat, the child is typically moved to a booster seat, which elevates the child so that the vehicle's seatbelt lies across the strong bones of the chest and pelvis rather than the abdomen and neck. For convenience and cost savings, many caregivers prefer a combination system in which a single seat assembly can be used first as a harnessed seat and later as a booster, with the booster portion being separable from the balance of the assembly.

To be effective and safe, such a combination seat must retain the booster securely within the balance of the assembly under the loads imposed by both vehicle operation and collision and must nevertheless permit a caregiver to remove and reattach the booster with minimal effort. Prior approaches have tended to require precise alignment of the booster with the base, to require the caregiver to simultaneously hold open a latch while seating the booster, or to employ latching geometry that is prone to partial or unreliable engagement. There remains a need for a securing mechanism that self-engages upon seating of the booster, positively locks without caregiver intervention, and releases cleanly upon a single caregiver action.

### SUMMARY OF THE INVENTION

The subject matter of this application pertains to methods and devices for providing a child safety car seat assembly having a removable booster section. In particular, it discloses a mechanical system for reversibly securing a booster to a larger shell assembly by means of one or more rotary-ratchet clamps.

In one aspect, a child safety seat comprises a shell defining a base having a platform and a back, a connecting rod fixed to the shell and extending transversely across a receiving portion of the base, and a booster adapted to be received in the receiving portion. The booster carries at least one clamp assembly, each clamp assembly comprising a locking wheel defining a clamping notch, a pawl, and a biasing element, the locking wheel being supported for rotation about a wheel axis oriented generally parallel to the connecting rod. In an open position, the clamping notch is oriented to receive the connecting rod. Downward seating of the booster onto the connecting rod causes the rod to bear against an inner surface of the clamping notch and to thereby drive the locking wheel from the open position toward a captive position in which the clamping notch wraps around a substantial portion of the circumference of the connecting rod. The pawl cooperates with the locking wheel permitting rotation toward the captive position while preventing rotation back toward the open position until the pawl is affirmatively released.

In a further aspect, the booster comprises an actuator operably coupled to the pawl of each clamp assembly such that a single actuating input by a caregiver releases each pawl and permits the booster to be lifted away from the shell, whereupon the locking wheels rotate back to the open position to receive the connecting rod upon subsequent reinstallation. In certain preferred embodiments the actuator is coupled to the pawl(s) through a Bowden cable.

One objective of this disclosure is to provide a simple method of connecting and disconnecting a removable booster of a child safety car seat with minimal effort on the caretaker's part. Another objective is to provide a securing mechanism that self-engages and positively locks in response to the act of installing the booster, without requiring the caretaker to hold a latch open during installation.

### BRIEF DESCRIPTION OF THE DRAWINGS

FIG. 1 is a perspective view of a shell of a child safety seat showing a connecting rod fixed to the shell and extending across a receiving portion of the shell.

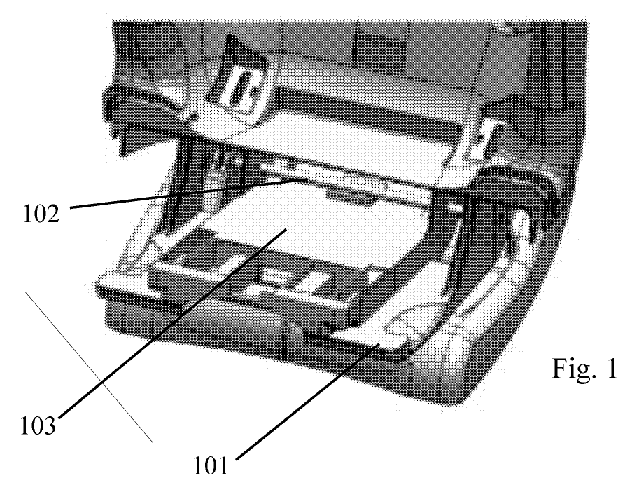

FIGS. 2a, 2b, and 2c are a sequence of perspective views illustrating engagement of a booster with the shell of FIG. 1.

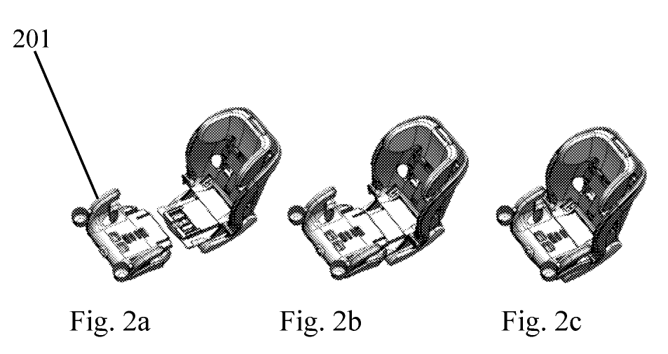

FIG. 3 is a side view of the rotary-ratchet clamp assembly illustrating the locking wheel, clamping notch, pawl, and biasing element. orig FIG. 7

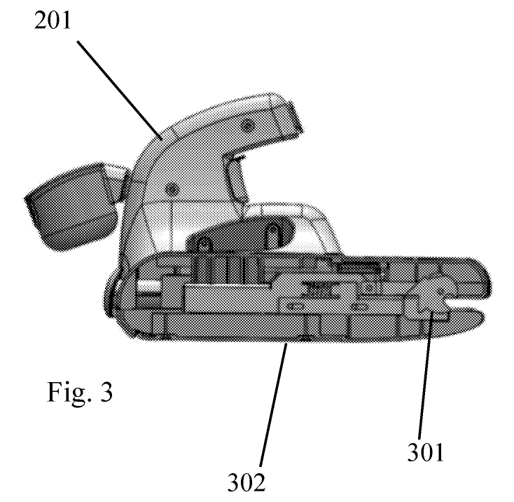

FIGS. 4a, 4b, and 4c are a sequence of side views illustrating rotation of the locking wheel from the open position (FIG. 4z) through an intermediate position (FIG. 4b) to the captive position (FIG. 4c) as the booster is seated onto the connecting rod.

FIG. 5 is an enlarged view of the locking wheel in the captive position, illustrating the clamping notch wrapping approximately sixty percent around the circumference of the connecting rod. orig 11

FIG. 6 is a guiding track structure on a base.

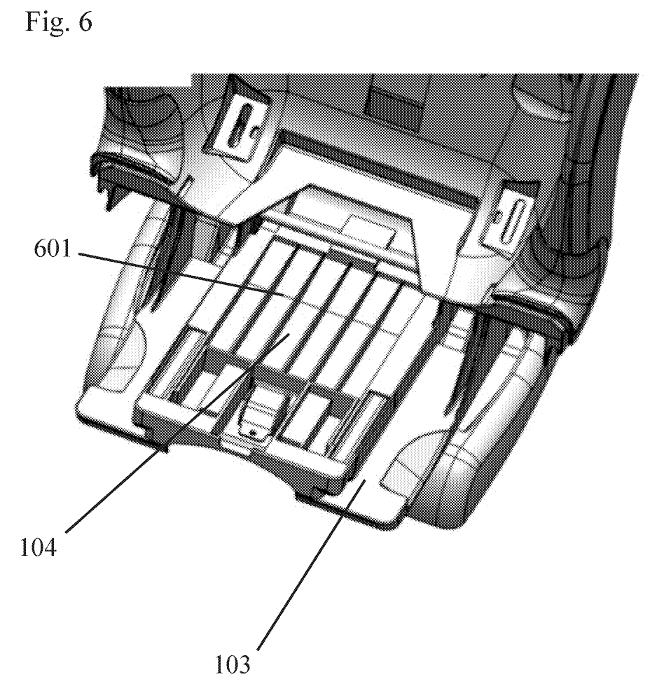

### DETAILED DESCRIPTION

While the exemplary embodiments illustrated in the figures and described herein are presently preferred, it should be understood that these embodiments are only examples. Accordingly, the present application is not limited to a particular embodiment but extends to various modifications that fall within the scope of the appended claims. The order or sequence of any processes or method steps may be varied or re-sequenced according to alternative embodiments.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating conditions, and arrangement of the exemplary embodiments without departing from the scope of the present application.

Uses of the verbs ‘include’ and ‘have’ should be understood to mean ‘comprise,’ i.e., the terms are inclusive and open-ended and do not exclude additional elements or steps. Words like “specifically,” “preferably,” “commonly,” and “typically” are used to highlight alternative or additional features that may or may not be utilized in a particular embodiment of the subject matter of this application and are not intended to limit the scope of the claimed invention or to imply that certain features are critical, essential, or even important to the structure or function of the claimed subject matter. Further, words like “substantially” and “about” are utilized herein to represent the inherent degree of uncertainty in any measurement.

Certain word choices are made for simplicity and to aid the reader's understanding by placing the application's subject matter in context. These word choices should not be interpreted to narrow the scope of the claims, which should be given their broadest possible meaning in light of the disclosure. For example, as used herein, the terms "child safety car seat," "car seat," and "safety seat" are interchangeable and include other similar vehicle seat adjuncts. The term "car" is used as a generic term for any type of vehicle. As used herein, a "car seat" is comprised of a "back" or "shell" and a "booster seat," "booster," or "seat" portion.

Reference numbers are given as three digits. The first digit refers to the illustration in which the referenced item is first or best shown.

The following description and the drawings referenced in it illustrate embodiments of the subject matter of this application. They are not intended to limit the scope of the claims. Those familiar with the relevant art will recognize that other embodiments of the disclosed subject matter are possible, and all such alternative embodiments are to be considered within the scope of this disclosure.

A car seat according to the present disclosure is comprised of a shell (101) and a booster seat (201). The shell comprises a connecting rod (102) and a receiving portion (103) adapted to receive the booster. The booster comprises at least one connector (301) adapted to secure the booster to the connecting rod. The booster further comprises an actuator.

In a highly preferred embodiment, there is a single connecting rod (102) comprising two ends and a center portion. The two ends are fixed and embedded in the shell, and the center portion is accessible and capable of attachment by the locking mechanism of the booster. Other embodiments comprise two or more connecting rods or similar members such as U-bolts. In still further embodiments, the connecting rod is supported on the booster and the corresponding clamp assembly is supported on the shell; the principles of the rotary-ratchet securing mechanism described below apply equally to that inverted configuration.

In preferred embodiments the booster comprises at least two connectors (e.g.,301) adapted to engage the connecting rod, the connectors being laterally spaced along the connecting rod so as to resist both vertical and rotational loads imposed on the booster. In the most highly preferred embodiments, each connector comprises a rotary-ratchet clamp assembly (401) of the type described below. In preferred embodiments, the actuator component of the booster is operably connected to the rotary-ratchet clamp assemblies through one or more linkages, such as, for example, a Bowden cable. Operation of the actuator by a person results in the rotary-ratchet clamp assemblies decoupling from the connecting rod.

In some preferred embodiments, the shell further comprises a seat platform (104). When the booster is properly inserted into the receiving portion (103) of the base, the bottom surface of the booster faces the top surface of the seat platform. In most embodiments the bottom surface (302) of the booster and the top surface of the seat platform are largely contiguous when the booster is properly inserted into the base. In certain embodiments, the bottom surface of the booster and the top surface of the seat platform further comprise a guiding track system (601) that guides the insertion of the booster into the receiving portion of the shell.

The securing mechanism of the booster comprises at least one, and preferably two, rotary-ratchet clamp assemblies (401). Each clamp assembly comprises a locking wheel (402), a pawl (403), and a biasing element (404). The locking wheel defines a clamping notch opening from a peripheral surface of the locking wheel. The locking wheel is mounted for rotation about a wheel axis. The wheel axis is oriented generally parallel to the connecting rod so that, upon rotation of the locking wheel, the clamping notch sweeps in a plane transverse to the connecting rod and is capable of receiving the connecting rod and capturing it within the notch.

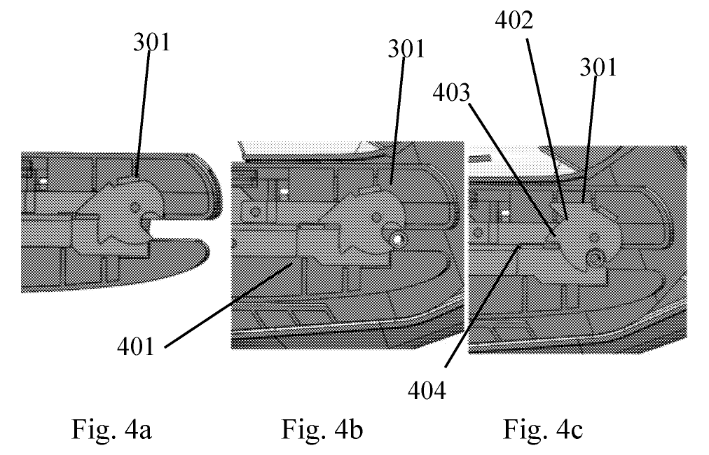

In the open position, the locking wheel is oriented such that the clamping notch faces generally downward to accept the connecting rod as the booster is moved into the shell (see FIG. 4a). The biasing element urges the locking wheel toward the open position in the absence of engagement with the connecting rod, and the pawl cooperates with the locking wheel to releasably retain the locking wheel in the open position when the booster is detached from the shell. In this way the caregiver is not required to manually hold the clamp assembly open while seating the booster.

As the booster is moved into the shell, the connecting rod enters the clamping notch and bears against an inner surface of the notch (see FIG. 4b). Continued pressure exerted by the caregiver causes the connecting rod to exert a tangential force against the inner surface of the notch, which drives the locking wheel to rotate about the wheel axis. As the locking wheel rotates, the clamping notch rotates around the connecting rod, bringing progressively more of the circumference of the connecting rod within the confines of the notch (see FIG. 4c).

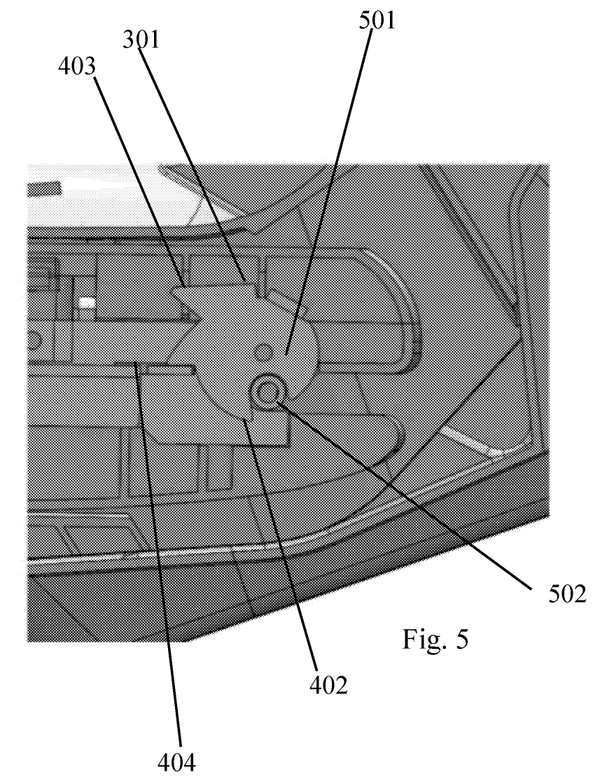

The pawl is configured to engage a ratchet surface of the locking wheel such that the locking wheel is permitted to rotate in a first direction, from the open position toward the captive position, but is prevented from rotating in the opposite direction. When the locking wheel reaches the captive position, the pawl drops into a latching recess of the ratchet surface and positively locks the locking wheel against reverse rotation. In the captive position (501), the clamping notch wraps around a substantial portion of the circumference of the connecting rod, thereby mechanically capturing the connecting rod within the notch and preventing separation of the booster from the shell (See FIG. 5).

Internal testing has shown that rotation of the locking wheel such that the clamping notch closes around approximately sixty percent of the circumference of the connecting rod sufficiently captures the connecting rod with minimal relative movement between the booster and the shell (502). In a preferred embodiment, the connecting rod is approximately ten millimeters in diameter, and in the captive position the clamping notch wraps approximately sixty percent around the ten-millimeter rod. It will be appreciated that other rod diameters and other wrap percentages, including wrap percentages greater than sixty percent and less than one hundred percent, may be employed without departing from the scope of the invention.

To release the booster from the shell, the caregiver operates the actuator of the booster. Operation of the actuator disengages the pawl from the ratchet surface of the locking wheel. With the pawl disengaged, the biasing element and/or the lifting force applied by the caregiver causes the locking wheel to rotate in the reverse direction, the clamping notch thereby opens, and the connecting rod passes out of the notch as the booster is lifted away from the shell. Upon full separation, the pawl re-engages the ratchet surface in the open position so that the locking wheel is again retained in the open position in readiness for subsequent reattachment.

In a highly preferred embodiment, the actuator comprises a handle or button mounted on the booster and operably coupled to the pawl of each clamp assembly through a Bowden cable. A single action by the caregiver on the actuator simultaneously disengages the pawl of each of the two clamp assemblies, permitting simultaneous release of both sides of the booster.

In another preferred embodiment, the actuator comprises a mechanical lever pivotally mounted on the booster and directly coupled to the pawl of each clamp assembly without an intervening cable. Operation of the lever directly displaces the pawl out of engagement with the ratchet surface. Other embodiments may use other types of actuators, such as electromechanical or hydraulic actuators.

It should be recognized by those familiar with the relevant arts that the locations of the connecting rod and of the rotary-ratchet clamp assemblies may be reversed, such that the connecting rod or rods are located on the booster and the rotary-ratchet clamp assemblies and actuator are located on the shell. In such inverted configurations, the principles of operation described above apply without substantive modification.

What is claimed is:

1. A child safety seat comprising:
a shell comprising a base having a platform and a back, the base further comprising a receiving portion; a connecting rod fixed to the shell and extending across the receiving portion of the base transverse to the back of the base; and
a booster sized and shaped to be received in the receiving portion, the booster comprising at least one clamp assembly, each clamp assembly comprising a locking wheel, a pawl, and a biasing element,
the locking wheel defining a clamping notch opening from a peripheral surface of the locking wheel,
the locking wheel being mounted for rotation about a wheel axis oriented generally parallel to the connecting rod; wherein the locking wheel is rotatable between
(i) an open position in which the clamping notch is oriented to receive the connecting rod as the booster is seated into the receiving portion, and
(ii) a captive position in which the clamping notch wraps around a portion of the circumference of the connecting rod so as to retain the connecting rod within the clamping notch;
wherein the locking wheel is arranged such that, as the booster is seated into the receiving portion, the connecting rod bears against an inner surface of the clamping notch and thereby drives the locking wheel from the open position to the captive position; and
wherein the pawl is configured to engage the locking wheel so as to permit rotation of the locking wheel from the open position toward the captive position while preventing rotation of the locking wheel from the captive position back toward the open position until the pawl is released.

2. The child safety seat of claim 1, wherein the booster comprises two clamp assemblies, each being laterally spaced along the wheel axis.

3. The child safety seat of claim 1, wherein the booster further comprises an actuator operably coupled to the pawl of each clamp assembly, the actuator being operable by a caregiver to disengage the pawl from the locking wheel and thereby permit the locking wheel to rotate from the captive position toward the open position.

4. The child safety seat of claim 3, wherein the actuator is operably coupled to the pawl of a clamp assembly by a Bowden cable.

5. The child safety seat of claim 3, wherein the actuator comprises a mechanical lever directly coupled to the pawl of at least one clamp assembly.

6. The child safety seat of claim 1, wherein, in the captive position, the clamping notch wraps around at least approximately sixty percent of the circumference of the connecting rod.

7. The child safety seat of claim 1, wherein the biasing element urges the locking wheel toward the open position, and wherein the pawl cooperates with the locking wheel to releasably retain the locking wheel in the open position when the booster is detached from the shell.

8. The child safety seat of claim 1, wherein the connecting rod comprises two ends fixed within the shell and a center portion that spans the receiving portion of the base and is engageable by the clamping notch of the locking wheel.

9. A child safety seat comprising:
a shell comprising a receiving portion;
a booster adapted to be received in the receiving portion of the shell;
a connecting rod supported on one of the shell and the booster; and
a clamp assembly supported on the other of the shell and the booster,
the clamp assembly comprising a locking wheel defining a clamping notch,
a pawl, and
a biasing element,
the locking wheel being mounted for rotation about a wheel axis oriented generally parallel to the connecting rod;
wherein relative seating movement between the booster and the shell causes the connecting rod to enter the clamping notch and to drive the locking wheel from an open position toward a captive position; and
wherein the pawl engages the locking wheel to prevent rotation of the locking wheel away from the captive position until the pawl is released.

10. The child safety seat of claim 9, further comprising an actuator operably coupled to the pawl by a Bowden cable, wherein operation of the actuator by a caregiver disengages the pawl and permits separation of the booster from the shell.
